(19) United States
(12) Patent Application Publication
(10) Pub. No.: US 2011/0239222 A1
(43) Pub. Date: Sep. 29, 2011

(54) SYSTEM AND METHOD OF DETERMINING APPLICABLE INSTALLATION INFORMATION OF APPARATUS

(75) Inventor: XIAO-BIN WU, Huai An (CN)

(73) Assignees: Hong Heng Sheng Electronical Technology (HuaiAn) C, Huai An City (CN); FOXCONN ADVANCED TECHNOLOGY INC., Tayuan (TW)

(21) Appl. No.: 12/978,429

(22) Filed: Dec. 24, 2010

(30) Foreign Application Priority Data
Mar. 29, 2010 (CN) 201010134145.2

(51) Int. Cl. G06F 9/50

(52) U.S. Cl. 718/104

(57) ABSTRACT

A computer and method obtains user input from an input device to determine applicable installation information of an apparatus according to resource consumption of the apparatus. The computer and method are capable of obtaining resource consumption information of an apparatus according to the installation material from an input device and operable to perform transformation processing to obtain installation data according to resource consumption information of the apparatus. Differences between the installation data and standard specifications are calculated and the specified standard specification corresponding to a difference which is the smallest number in the differences is found. The specified standard specification is outputted.

### BACKGROUND

1. Technical Field

The present disclosure generally relates to a system and a method of determining applicable installation information of an apparatus according to resource consumption of the apparatus.

2. Description of Related Art

Many types of apparatus generally require more than one resource to operate, such as water, electricity, and air. For example, an apparatus for etching a printed circuit board can need 35 liters per minute of a cleaning liquid such as water. Facility engineers have to determine specifications of installation material, for example, amount and size of water pipes needed, before installation of the apparatus. In addition, if the determined specification of the installation material does not correspond to any standard specifications, then a nearest fit must be chosen, which may not be apparent and require much time of the designers to select and choose. All of this can be a waste of material, space, and money.

What is needed, therefore, is a system and a method of determining applicable installation information of an apparatus according to resource consumption of the apparatus, that overcomes the aforementioned problem.

### BRIEF DESCRIPTION OF THE DRAWINGS

Many aspects of the present embodiment may be better understood with reference to the following drawings. The components in the drawings are not necessarily drawn to scale, the emphasis instead being placed upon clearly illustrating the principles of the present apparatus. Moreover, in the drawings, all the views are schematic, and like reference numerals designate corresponding parts throughout the several views.

FIG. 1 is a block diagram of one embodiment of a computer comprising a determining system, wherein the determining system is operable to determine installation information of an apparatus according to resource consumption information of the apparatus.

FIG. 2 is a schematic diagram illustrating an example of a user interface of the computer of FIG. 1.

FIG. 3 is a flow diagram illustrating a process of determining installation information of an apparatus according to resource consumption information of the apparatus using the computer of FIG. 1.

### DETAILED DESCRIPTION

The application is illustrated by way of examples and not by way of limitation in the figures of the accompanying drawings in which like references indicate similar elements. In general, the word “module” as used hereinafter, refers to logic embodied in hardware or firmware, or to a collection of software instructions, written in a programming language, for example, Java. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

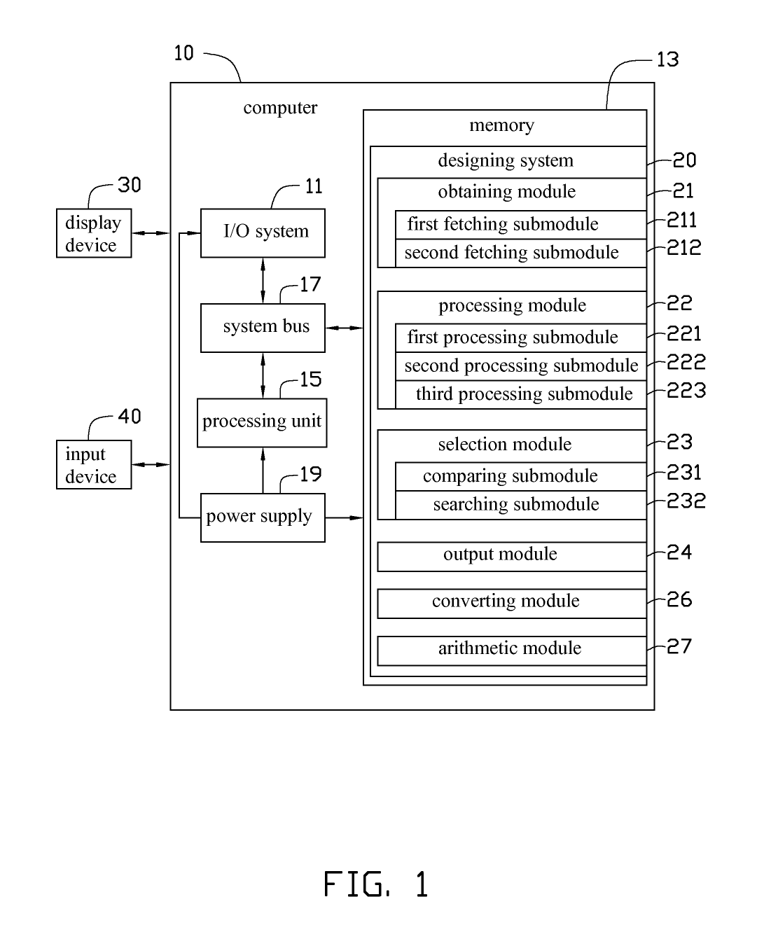

FIG. 1 is a block diagram of one embodiment of a computer 10 comprising a determining system 20. The determining system 20 is operable to determine installation information of an apparatus according to resource consumption information of the apparatus.

In one embodiment, the computer 10 is electronically connected to a display device 30 and an input device 40. The display device 30 may be a liquid crystal display (LCD) or a cathode ray tube (CRT) display, for example. The input device 40 is provided for manually inputting resource consumption information of an apparatus. The input device 40 may be a keyboard, a keypad, or a touch screen, for example.

The computer 10 further includes an I/O system 11, a processing unit 13, a memory 15, a system bus 17, and a power supply 19. The system bus 17 is used to electronically communicate the I/O system 11, the processing unit 11, the memory 15, and the power supply 19 with each other, and generally includes a data bus, an address bus, a control bus, and a power bus. The data bus is used for transferring data between the I/O system 11, the processing unit 13, and the memory 15. The address bus specifies the memory locations (addresses) for the data transfers. When the processing unit 13 needs to read or write to a memory location, it specifies that memory location on the address bus, wherein the value to be read or written is sent on the data bus. The control bus is used to provide control information communication. The power bus is electrically connected with the power supply 19. Thus, the power supply 19 supplies power to the I/O system 11, the processing unit 13, and the memory 15 with the power bus.

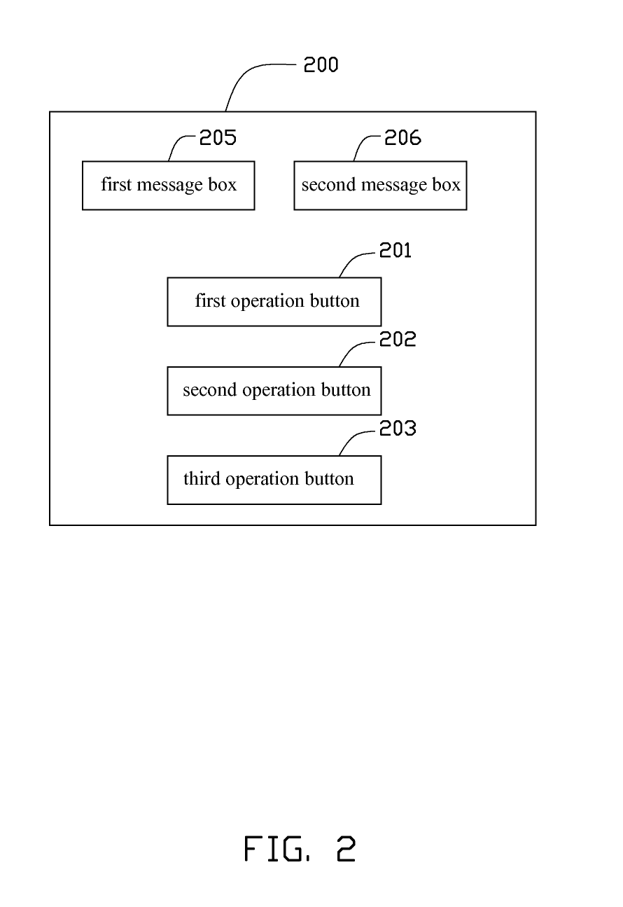

The I/O system 11 provides both an input interface and an output interface between the computer 10 and a user. In the present embodiment, a user interface 200 communicates with the input interface and the output interface is shown on the display device 30, as shown in FIG. 2. That is, the display device 30 functions as an output device, used to show output information of the I/O system 11. The input device 40 communicates with the I/O system 11. Thus, the user can operate the input device 40 to input information and commands into the computer 10.

The memory 15 is capable of storing information, such as a number of standard specifications of one or more installation materials. In the present embodiment, standard specifications of three installation materials, namely, electrical cables, pipes for pumping liquids, and ducts to direct the flow of gases, are stored in the memory 15. In this embodiment, water and air are used as examples of liquid and gas installation materials. The standard specifications of installation material may include, for example, standard cross-section areas of cable of 1.5 mm² (square millimeters), 2.5 mm², 4 mm², 6 mm², 10 mm², 16 mm², 25 mm², 35 mm², 50 mm², 75 mm², 90 mm², 100 mm², 120 mm², 180 mm², and so on. For another example, diameters of the water pipes produced by the water pipes manufacturer such as 0.17 inch, 0.25 inch, 0.5 inch, 0.75 inch, 1 inch, 1.25 inch, 1.5 inch, 2 inch, 2.5 inch, 3 inch, 4 inch, 5 inch, 6 inch, 8 inch, 10 inch, and so on.

The memory 15 is also used for storage of function modules (or sets of instructions), that may be executed by the processing unit 13 of the computer 10 to implement one or more operations of the computer 10.

The determining system 20 includes an obtaining module 21, a processing module 22, a selection module 23, and an output module 24. In one embodiment, the modules 21 through 24 comprise one or more computerized codes/instructions that are embodied in the memory 15. The processing unit 13 can execute the computerized codes/instructions of the modules 21 through 24.

The obtaining module 21 obtains user input from the input device 40. In detail, the obtaining module 21 includes a first fetching submodule 211 and a second fetching submodule 212. The first fetching submodule 211 obtains the kind of the installation materials, that is, cables, water pipes, or air ducts. The second fetching submodule 212 obtains the resource consumption information about a corresponding installation material. The resource consumption information corresponding to the cable is rated voltage and total power. The resource consumption information corresponding to the water pipes can include mass flow rate. The resource consumption information corresponding to the air ducts can be air velocity and air volume.

The processing module 22 performs transformation processing to obtain installation data of the corresponding installation material according to the resource consumption information. There are transformation relationships between the installation data and the resource consumption information. In the present embodiment, the processing module 22 includes a first processing submodule 221, a second processing submodule 222, and a third processing submodule 223. The submodules 221 through 223 correspond to the installation materials of cables, water pipes, and air ducts, respectively. That means, the first processing submodule 221 is capable of transforming the input electricity consumption information of the apparatus to installation data about the cables used in installation of the apparatus, such as length and cross-section area of the cable. The second processing submodule 222 is capable of obtaining the installation data of the water pipes used in the installation of the apparatus according to the input water consumption information. The installation data of the water pipes may include but is not limited to the diameter, length and material of the water pipes. For instance, the diameter of the water pipes (R) can be obtained according to the equation: m=ρvπR²/4. In the equation, m denotes to the mass flow rate, ρ denotes the density, v denotes to the velocity. If V, v, and ρ were known, R can be calculated from the equation. The third processing submodule 223 is capable of performing processing of the input air consumption information of the apparatus to obtain the diameter of the air ducts used in the installation of the apparatus. For instance, if the rated voltage is 380 volts, every 1000 watts of power of the apparatus corresponds to 1.9 amperes of current in the cable. And then according to Empirical Formula between the current and the cross-section area of the cable, the installation information of the cable can be obtained.

The selection module 23 selects one from the standard specifications of a corresponding installation material. In particular, the selection module 23 includes a comparing submodule 231 and a searching submodule 232. The comparing submodule 231 performs calculation to obtain differences between the installation data and each of the standard specifications of the corresponding installation material stored in the memory 15. The searching submodule 232 finds the standard specification corresponding to the difference which is the smallest number in the differences. In other words, the searching submodule 232 finds the standard specification which is larger than the installation data and most adjacent to the installation data. For example, when the diameter of the water pipes calculated by the processing module 22 is 4.1 inches, then the standard specification of 5 inch in diameter is selected by the selection module 23. When the diameter of the water pipes calculated by the processing module 22 is 6 inches, then the standard specification of 7 inch in diameter is selected by the selection module 23. The output module 24 outputs the standard specification which is selected by the selection module 23. That is, the output module 24 communicates with the searching submodule 232, and outputs the specified standard specification found by the searching submodule 232. Thus, the display device 30 can show the specified standard specification thereon.

In one embodiment, the determining system 20 further includes a unit converting module 26 and an arithmetic module 27. The unit converting module 26 converts number between different units. For example, 2 inches can be converted into 0.508 meters. The arithmetic module at least performs the four fundamental operations of arithmetic (addition, subtraction, division, multiplication). The unit converting module 26 and the arithmetic module 27 can facilitate the user to use the determining system 20.

In the present embodiment, the user interface 200 of the determining system 20 is shown in FIG. 2. The user interface 200 has a first operation button 201, a second operation button 202, a third operation button 203, a first message box 205, and a second message box 206 shown thereon. The resource consumption information can be input into the determining system 10 by the input device 40, and then displayed on the first message box 205. After electricity consumption information of an apparatus is input into the determining system 20, the first operation button 201 can be clicked by a user using the input device 40 thereby triggering the first processing submodule 221 and the selection module 24 to obtain one qualified standard specification of the cable in installation. After water consumption information of an apparatus is input into the determining system 20, the second operation button 202 can be clicked by a user using the input device 40 thereby triggering the second processing submodule 222 and the selection module 24 to obtain one qualified standard specification of the water pipes used in installation. After air consumption information of an apparatus is input into the determining system 20, the third operation button 203 can be clicked by a user using the input device 40 thereby triggering the third processing submodule 223 and the selection module 24 to obtain one qualified standard specification of the air ducts in installation.

It is understood that the user interface 200 may be other suitable structures, for example, it can just include one operation button. It should be appreciated that the computer 10 is only one exemplary embodiment, and that the computer 10 may have more or fewer components than shown, or a different configuration of components. The various components shown in FIG. 1 may be implemented in hardware, software or a combination of both, hardware and software, including one or more signal processers and/or application specific integrated circuits.

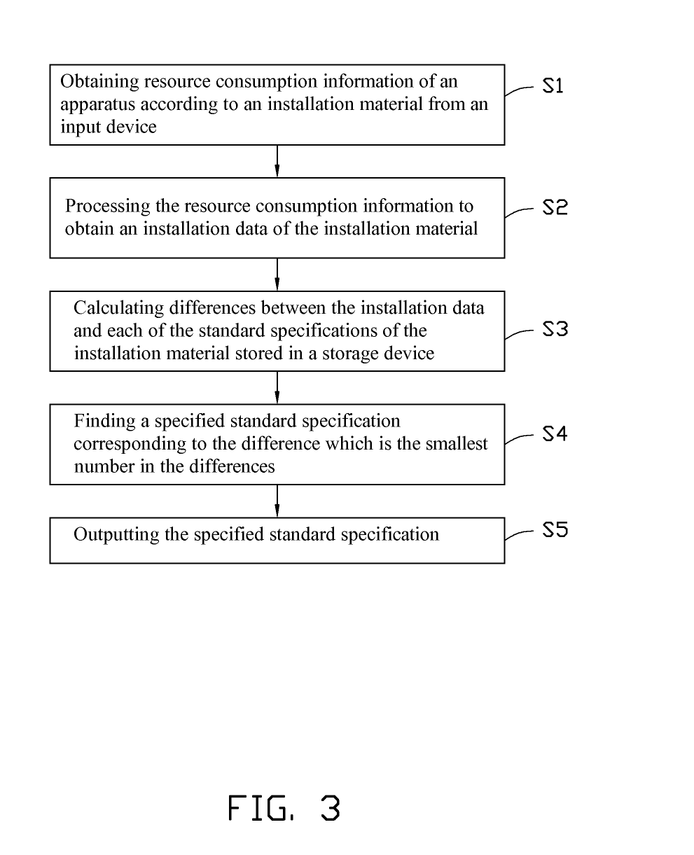

FIG. 3 is a flowchart of one embodiment of a method of determining applicable installation information of an apparatus, using the computer 10 of FIG. 1. Depending on the embodiment, additional blocks may be added, others removed, and the ordering of the blocks may be changed.

In block S1, the resource consumption information of an apparatus corresponding to an installation material is obtained from an input device 40, when a user inputs the resource consumption information using the input device 40.

In block S2, the processing module 22 performs transforming processing to obtain an installation data of the installation material according to the resource consumption information.

In block S3, differences between the installation data and each of a plurality of standard specifications of the installation material stored in the memory 13 are calculated by the comparing submodule 231.

In block S4, a specified standard specification corresponding to the difference which is the smallest number in the differences is selected by the searching submodule 232.

In block S5, the output module 24 outputs the specified standard specification to the display device 30, and then the specified standard specification is shown on the display device 40.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

1. A computing system for determining applicable installation information of an apparatus according to resource consumption of the apparatus, the system comprising:
a storage device for storing a plurality of standard specifications of an installation material;
an obtaining module operable to obtain resource consumption information of an apparatus according to the installation material from an input device;
a processing module operable to perform transformation processing to obtain installation data according to the resource consumption of the installation material;
a selection module including a comparing submodule and a searching submodule, the comparing submodule being operable to calculate differences between the installation data and each of the plurality of standard specifications of the installation material stored in the storage device, the searching submodule being operable to find the specified standard specification corresponding to a difference which is the smallest number in the differences; and
an output module operable to output the specified standard specification.

2. The system of claim 1, wherein the storage device stores standard specifications of three kinds of installation materials, the obtaining module comprises a first fetching submodule and a second fetching submodule, the first fetching submodule being operable to obtain one kind of the installation materials from the input device, the second fetching submodule being operable to obtain resource consumption information from the input device.

3. The system of claim 2, wherein the processing module comprises a first processing submodule, a second processing submodule, and a third processing submodule capable of perform transformation processing of the three kinds of installation materials, respectively.

4. The system of claim 3, wherein the three kinds of installation materials are electrical cables, pipes for pumping liquids, and ducts to direct the flow of gases.

5. The system of claim 1, wherein the system further comprises a unit converting module and an arithmetic module, the unit converting module is operable to convert number between different units, and the arithmetic module is at least operable to perform the four fundamental operations of arithmetic.

6. A computer-implemented method of determining applicable installation information of an apparatus according to resource consumption of the apparatus, the method comprising:
obtaining resource consumption information of an apparatus according to an installation material from an input device;
processing the resource consumption information to obtain an installation data of the installation material;
calculating differences between the installation data and each of a plurality of standard specifications of the installation material stored in a storage device;
finding a specified standard specification corresponding to the difference which is the smallest number in the differences;
outputting the specified standard specification.

7. The method of claim 6, further comprising obtaining the kind of the installation material from the input device prior to the step of obtaining resource consumption information.

8. The method of claim 6, wherein the resource consumption information of an apparatus is selected from the group consisting of electricity consumption information, liquid consumption information, and gas consumption information.

9. The method of claim 6, wherein the specified standard specification is output and shown on a display device.

10. A storage medium having stored thereon instructions that, when executed by a processor of a computer, cause the processor to perform a method of determining applicable installation information of an apparatus according to resource consumption of the apparatus, the method comprising:
obtaining resource consumption information of an apparatus according to an installation material from an input device;
processing the resource consumption information to obtain an installation data of the installation material;
calculating differences between the installation data and each of a plurality of standard specifications of the installation material stored in a storage device;
finding a specified standard specification corresponding to the difference which is the smallest number in the differences;
outputting the specified standard specification.

11. The storage medium of claim 10, wherein the resource consumption information of an apparatus is selected from the group consisting of electricity resource consumption information, water consumption information, and air consumption information.

12. The storage medium of claim 10, wherein the specified standard specification is output and shown on a display device.
